(19) United States
(12) Patent Application Publication
(10) Pub. No.: US 2008/0225294 A1
(43) Pub. Date: Sep. 18, 2008

(54) APPARATUS FOR CHECKING CONCENTRICITY AND METHOD FOR CHECKING SAME

(75) Inventor: SHIH-CHIEH YEN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/940,581

(22) Filed: Nov. 15, 2007

(30) Foreign Application Priority Data
Mar. 14, 2007 (CN) 200710200279.8

(51) Int. Cl. G01B 11/00

(52) U.S. Cl. 356/399

(57) ABSTRACT

An exemplary apparatus for checking concentricity between a holder and a lens barrel of a lens module includes a light source, a gauge, and a detecting and analyzing device. The gauge includes an inner barrel and an outer barrel. The inner barrel is capable of rotating to a predetermined angle relative to the outer barrel. The inner barrel is configured for coupling with the lens barrel of the lens module. In addition, a method for checking the concentricity is also provided.

### BACKGROUND

1. Technical Field

The present invention relates to optical imaging field and, particularly, to an apparatus for checking concentricity between a holder and a lens barrel of a lens module and a method for checking the same.

2. Description of Related Art

In production of lens modules, it is necessary to check concentricity between a holder and a lens barrel of the lens module (i.e., a deviation between a central axis of the holder and a central axis of the lens barrel). Generally, an optical axis of the lens barrel is considered as the central axis of the lens barrel, since the optical axis of the lens barrel is often coincident with the central axis of the lens barrel. So the deviation between the central axis of the holder and the central axis of the lens barrel is equivalent to that between the central axis of the holder and the optical axis of the lens barrel. A typical method for checking the concentricity includes:

emitting a first light beam along an optical axis of the lens barrel, forming a first light spot on a detecting apparatus, and recording a position of the first light spot (i.e., a first position of the optical axis of the lens barrel);
manually rotating the lens barrel to a predetermined angle relative to the holder;
emitting a second light beam along the optical axis of the lens barrel, forming a second light spot on the detecting apparatus, and then recording a position of the second light spot (i.e., a second position of the optical axis of the lens barrel 24); and
analyzing a deviation between the first position of the optical axis and the second position of the optical axis. If the deviation is larger than an allowable error, the lens module is deemed unsatisfactory.

In this typical method, the lens barrel is rotated manually relative to the holder in the above method. It is, accordingly, difficult to rotate the lens barrel to a precise predetermined angle every time. As such, the checking results tend to have a low precision.

It is therefore desirable to find a new apparatus and a new method for checking concentricity between a holder and a lens barrel of a lens module, which can overcome the above mentioned problems.

### SUMMARY

An exemplary apparatus for checking concentricity between a holder and a lens barrel of a lens module includes a light source, a gauge, and a detecting and analyzing device. The gauge includes an inner barrel and an outer barrel. The inner barrel is capable of rotating a predetermined angle relative to the outer barrel. The inner barrel is configured for coupling with the lens barrel of the lens module.

A method for checking concentricity between a holder and a lens barrel of a lens module, the method including:

coupling a gauge to the lens barrel, the gauge incorporating an inner barrel and an outer barrel, the inner barrel being capable of rotating to a predetermined angle relative to the outer barrel;
emitting a first light beam along an optical axis of the lens barrel, forming a first light spot, and recording a position of the first light spot;
rotating the inner barrel to a predetermined angle relative to the outer barrel;
emitting a second light beam along the optical axis of the lens barrel, forming a second light spot, and recording a position of the second light spot; and
analyzing a deviation between the position of the first light spot and that of the second light spot.

### BRIEF DESCRIPTION OF THE DRAWINGS

Many aspects of the present apparatus and method for checking concentricity between a holder and a lens barrel of a lens module can be better understood with references to the following drawings. The components in the drawings are not necessarily drawn to scale, the emphasis instead being placed upon clearly illustrating the principles of the present apparatus and method for checking concentricity. Moreover, in the drawings, like reference numerals designate corresponding parts throughout the several views.

FIG. 1 is a schematic, exploded view of a present apparatus for checking concentricity of a to-be-checked lens module;

FIG. 2 is a schematic, perspective view of the apparatus and the lens module of FIG. 1, in which the lens module is fixed with the apparatus;

FIG. 3 is a schematic, side cross-sectional view of the apparatus and the lens module of FIG. 1, taken along the line III-III thereof;

FIG. 4 is a schematic, isometric view of a gauge of the apparatus of FIG. 1;

FIG. 5 is a schematic, isometric view of a gauge of a second present embodiment;

FIG. 6 is a schematic, isometric view of a gauge of a third present embodiment; and

FIG. 7 is a schematic, isometric view of a gauge of a fourth present embodiment.

### DETAILED DESCRIPTION OF THE EMBODIMENTS

Embodiments will now be described in detail below with reference to the drawings.

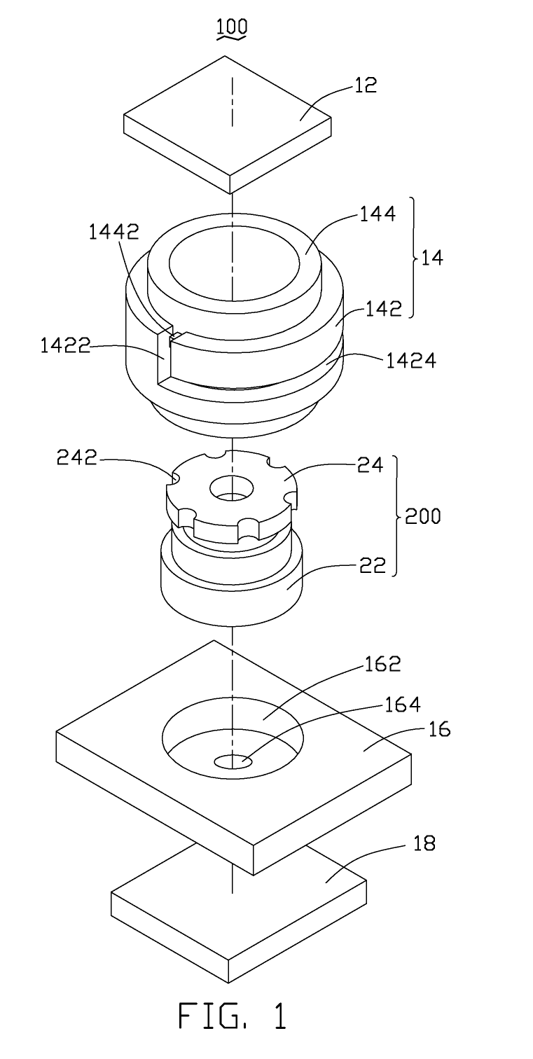

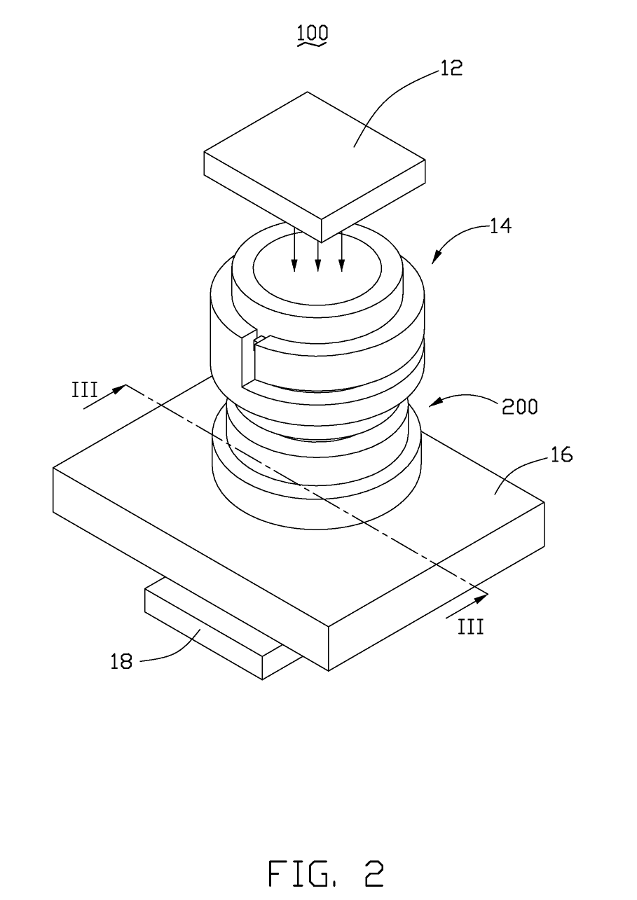

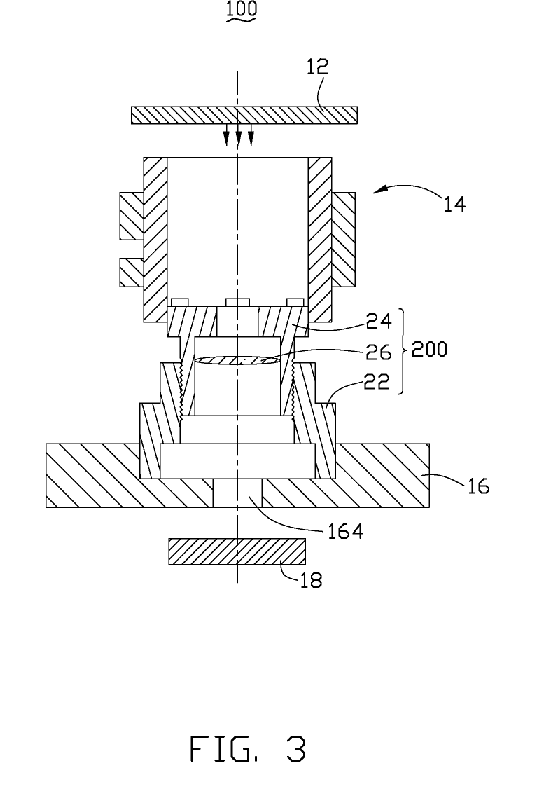

Referring to FIGS. 1 to 3, an apparatus 100 for checking concentricity, according to a first present embodiment, is shown. The apparatus 100 is for checking the concentricity between a holder 22 and a lens barrel 24 in a to-be-checked lens module 200. That is, the apparatus 100 is for checking a deviation between a central axis of the holder 22 and a central axis of the lens barrel 24. An optical axis (not labeled) of the lens barrel 24 is considered as the central axis of the lens barrel 24, since the optical axis of the lens barrel 24 is often coincident with the central axis of the lens barrel 24. So the deviation between the central axis of the holder 22 and the central axis of the lens barrel 24 is equivalent to that between the central axis of the holder 22 and the optical axis of the lens barrel 24.

The lens module 200 includes a holder 22, a lens barrel 24, and at least one lens 26 disposed in the lens barrel 24. The lens barrel 24 defines a plurality of grooves 242 at one end thereof. The lens barrel 24 is coupled to the holder 22, in a threaded manner. The grooves 242 extend essentially parallel to the central axis of the lens barrel 24 and, likewise, fully extend from a top side to a bottom side of the lens barrel.

The apparatus 100 includes a light source 12, a gauge 14, a working stage 16, and a detecting and analyzing device 18.

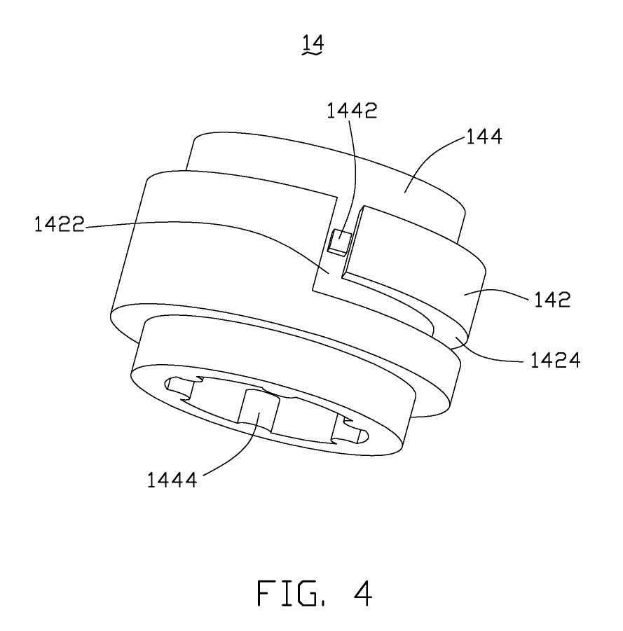

Referring to FIG. 4, the gauge 14 includes an inner barrel 144 and an outer barrel 142. The inner barrel 144 is capable of rotating a predetermined angle θ (0°<θ<360°) relative to the outer barrel 142. In the present embodiment, θ is equal to 180°. A spring (not shown) is connected between the inner barrel 144 and the outer barrel 142. The spring is configured for restoring the gauge 14 to an initial state after the inner barrel 144 has been rotated relative to the outer barrel 142 (more details will be described later).

The inside of the inner barrel 144 has a plurality of first protrusions 1444 formed thereon, with such first protrusions 1444 extending parallel to the central axis of the barrel 14. The outside of the inner barrel 144 has a second protrusion 1442 formed thereon. The first protrusions 1444 are configured (i.e., structured and arranged) for coupling (i.e., forming a slide fit) with the grooves 242 of the lens barrel 24. Since the first protrusions 1444 couple with the grooves 242 of the lens barrel 24 in this manner, when the inner barrel 144 is rotated, the lens barrel 24 is correspondingly driven to rotate.

The outer barrel 142 defines an L-shaped groove therein that is configured for receiving the second protrusion 1442. The L-shaped groove includes a horizontal groove 1424, extending radially around a portion of the lens barrel 24, and a vertical groove 1422, extending parallel to central axis of the lens barrel 24 and perpendicular to the horizontal groove 1424. The second protrusion 1442 is insertable into the vertical groove 1422 until reaching the horizontal groove 1424. Upon insertion in such a manner, the second protrusion 1442 is able to move/travel along the horizontal groove 1424, when the inner barrel 144 is rotated relative to the outer barrel 142. That is, the horizontal groove 1424 and the vertical groove 1422 serve as guide rails for the second protrusion 1442. A length of the horizontal groove 1424 depends on the predetermined angle θ. In the present embodiment, the predetermined angle θ is equal to 180°. Accordingly, the length of the horizontal groove 1424 is half of a circle of the outer barrel 142 (specifically, ½ C=π*r, where C is the circumference of the outer barrel 142 and r is the radius thereof). Likewise, when the length of the horizontal groove 1424 is a quarter of the circle of the outer barrel 142, the predetermined angle θ is equal to 90°.

When the inner barrel 144 is to be rotated relative to the outer barrel 142, the inner barrel 144 is, first, pressed down along the vertical groove 1422. Then, the inner barrel 144 is rotated counterclockwise relative to the outer barrel 142, in such a manner that the second protrusion 1442 moves along the horizontal groove 1422, until the second protrusion 1442 reaches a first end of the horizontal groove 1422. In this way, the inner barrel 144 is rotated relative to the outer barrel 142, to the predetermined angle θ=180°.

In order to restore the gauge 14 to an initial state, the inner barrel 144 is rotated clockwise relative to the outer barrel 142, in such a manner that the second protrusion 1442 moves along the horizontal groove 1422, until the second protrusion 1442 reaches a second end of the horizontal groove 1422. Then the inner barrel 144 is forced up relative to the outer barrel 142 by the spring. In this way, the gauge 14 restores to the initial state.

Referring to FIGS. 1 to 3 again, the working stage 16 has a groove 162 and a through hole 164 defined therein. The groove 162 is configured for accommodating the lens module 200. The through hole 164 is configured for allowing a light beam emitted from the light source 12 to pass therethrough.

The detecting and analyzing device 18 is configured for recording a given position of the optical axis of the lens barrel 24 and analyzing a deviation between a first recorded position of the optical axis and a second recorded position of the optical axis. A detecting surface of the detecting and analyzing device 18 is advantageously placed on/in a focus plane of the lens 26.

A method for checking the concentricity of the lens module 200 by using the apparatus 100 includes the following steps:

placing the lens module 200 into the groove 162 of the working stage 16, securing the lens module 200 to the working stage 16, and coupling the gauge 14 to the lens module 200;
emitting a first light beam along the optical axis of the lens barrel 24 from the light source 12, forming a first light spot (not shown) on the detecting and analyzing device 18, and then recording a position of the first light spot (i.e., a first position of the optical axis of the lens barrel 24);
pressing the inner barrel 144 down vertically, in such a manner that the second protrusion 1442 moves along the vertical groove 1422, rotating the inner barrel 144 counterclockwise relative to the outer barrel 142, in such a manner that the second protrusion 1442 moves along the horizontal groove 1422, until the second protrusion 1442 reaches a first end of the horizontal groove 1422. In this way, the inner barrel 144 is rotated relative to the outer barrel 142 to a predetermined angle θ. Because the holder 22 is fastened to the working stage 16 and the inner barrel 144 drives the barrel 24 to rotate, the lens barrel 24 rotates to the predetermined angle θ relative to the holder 22. In the present embodiment, as illustrated, θ=180°.
emitting a second light beam along the optical axis of the lens barrel 24, forming a second light spot (not shown) on the detecting and analyzing device 18, and then recording a position of the second light spot (i.e., a second position of the optical axis of the lens barrel 24); and
analyzing a deviation between the first position of the optical axis and the second position of the optical axis. If the deviation is not larger than an allowable error, the lens module 200 is deemed satisfactory; if the deviation is larger than the allowable error, the lens module 200 is deemed unsatisfactory. The deviation results, as determined by such an analysis, may be displayed/outputted using any of a variety of modes (not shown), e.g., a display screen, signal lights (e.g., red=unsatisfactory; green=satisfactory), audio signal, etc.

After the checking of the lens module 200 is done and the results are outputed, the inner barrel 144 is rotated clockwise relative to the outer barrel 142, in such a manner that the second protrusion 1442 moves along the horizontal groove 1422 until the second protrusion 1442 reaches a second end of the horizontal groove 1422. Then the inner barrel 144 is forced up relative to the outer barrel 142 by the spring, in such a manner that the second protrusion 1442 automatically moves along the vertical groove 1422. In this way, the gauge 14 restores to the initial state. The above steps (1)-(5) can be repeated to check a next lens module 200.

In the present embodiment, the lens barrel 24 is rotated relative to the holder 22 to the predetermined angle θ (e.g., θ=180°). The predetermined angle θ could instead be, for example, 90° or 270°. In addition, the lens barrel 24 can be rotated relative to the holder 22 to several different predetermined angles by using multiple different gauges similar to the gauges 14 (see FIG. 1). In this way, several positions of the optical axis can be recorded, thus improving checking precision.

In the above embodiment, the apparatus 100 includes a gauge 14. The gauge 14 includes an inner barrel 144 and an outer barrel 142. The inner barrel 144 can be rotated relative to the outer barrel 142 to a certain, exact predetermined angle every time. So the lens barrel 24 can be rotated relative to the holder 22 to the particular predetermined angle every time. Therefore, the checking progress is more convenient, and the checking precision is enhanced.

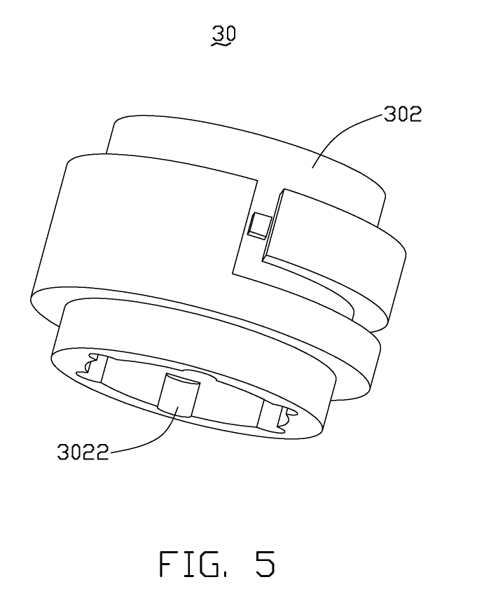

Referring to FIG. 5, a gauge 30 of a second embodiment is shown. The gauge 30 is similar to the gauge 14, but the inner barrel 302 defines a plurality of recesses 3022 therein. The recesses 3022 are configured for coupling with the lens barrel 24, wherein the lens barrel 24 has a plurality of protrusions formed on one end thereof.

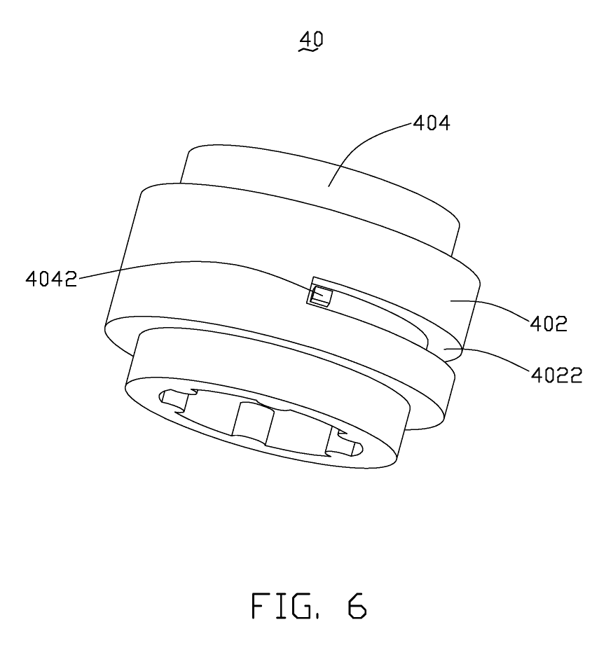

Referring to FIG. 6, a gauge 40 of a third embodiment is shown. The gauge 40 is similar to the gauge 14, but the outer barrel 402 defines only one horizontal groove 4022 therein and has no vertical groove.

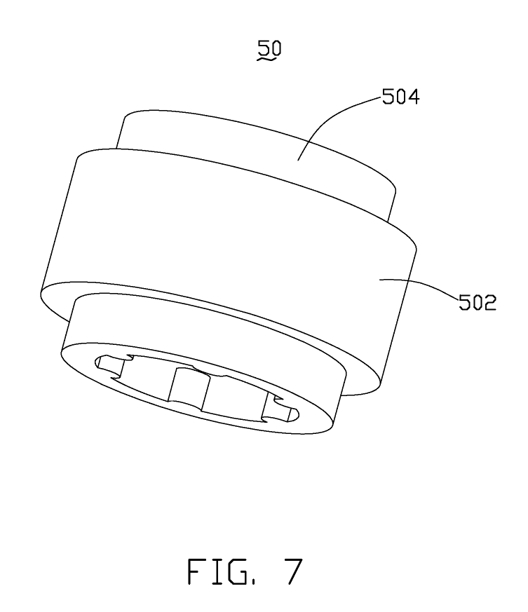

Referring to FIG. 7, a gauge 50 of a fourth embodiment is shown. The gauge 50 is similar to the gauge 14, but the outer barrel 502 defines no groove therein. The outer barrel 502 is coupled with the inner barrel 504, in a threaded manner. With this embodiment, the inner barrel 504 is rotated clockwise relative to the outer barrel 502, until an end of a threading is reached. When the end of the threading is reached, the user is thereby able to confirm that the inner barrel 504 is rotated to a predetermined angle θ (0°<θ<360°) relative to the outer barrel 502. The predetermined angle θ can be, e.g., 180°.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. An apparatus for checking concentricity between a holder and a lens barrel of a lens module, the apparatus comprising:
a light source;
a gauge comprising an inner barrel and an outer barrel, the inner barrel being capable of rotating to a predetermined angle relative to the outer barrel, the inner barrel being configured for coupling with the lens barrel of the lens module; and
a detecting and analyzing device.

2. The apparatus as claimed in claim 1, wherein the outer barrel defines a first groove therein, and the inner barrel has a protrusion formed on a side wall thereof, the protrusion being received in the first groove.

3. The apparatus as claimed in claim 2, wherein the outer barrel further defines a second groove therein, the second groove communicating with the first groove and being perpendicular thereto.

4. The apparatus as claimed in claim 1, wherein the outer barrel is coupled to the inner barrel, in a threaded manner.

5. The apparatus as claimed in claim 1, wherein the inner barrel has a plurality of protrusions formed thereon, the protrusions being configured for coupling with the lens barrel of the lens module.

6. The apparatus as claimed in claim 1, wherein the inner barrel defines a plurality of recesses therein, the recesses being configured for coupling with the lens barrel of the lens module.

7. The apparatus as claimed in claim 1, further comprising a working stage, the working stage being configured for securing the holder.

8. The apparatus as claimed in claim 7, wherein the working stage defines a groove therein, the groove being configured for accommodating the holder.

9. The apparatus as claimed in claim 1, wherein the predetermined angle is selected from a group consisting of: 90°, 180°, and 270°.

10. A method for checking concentricity between a holder and a lens barrel of a lens module, the method comprising the steps of:
coupling a gauge to the lens barrel, the gauge comprising an inner barrel and an outer barrel, the inner barrel being capable of rotating to a predetermined angle relative to the outer barrel;
emitting a first light beam along an optical axis of the lens barrel, thereby forming a first light spot, and then recording a position of the first light spot;
rotating the inner barrel to a predetermined angle relative to the outer barrel;
emitting a second light beam along the optical axis of the lens barrel, thereby forming a second light spot, and then recording a position of the second light spot; and
analyzing a deviation between the position of the first light spot and that of the second light spot.
